(19) United States
(12) Patent Application Publication
(10) Pub. No.: US 2021/0259813 A1
(43) Pub. Date: Aug. 26, 2021

(54) Cosmetic Orthodontic Braces

(71) Applicant: Patrick Wayne Villanueva, Fayetteville, NC (US)

(72) Inventor: Patrick Wayne Villanueva, Fayetteville, NC (US)

(21) Appl. No.: 17/184,444

(22) Filed: Feb. 24, 2021

Related U.S. Application Data
(63) Continuation-in-part of application No. 29/746,959, filed on Aug. 18, 2020.
(60) Provisional application No. 62/980,507, filed on Feb. 24, 2020.

(51) Int. Cl. A61C 7/30

(52) U.S. Cl. CPC A61C 7/303

(57) ABSTRACT

The present invention is a cosmetic dental insert that combines vacuum-formed retainers with orthodontic braces to produce a cosmetically appealing appearance of braces along translucent vacuum-formed retainers. The cosmetic dental insert contains a first dental fitment, a second dental fitment, a first set of braces, and a second set of braces. The first dental fitment and the second dental fitment each comprises a fitment body, a teeth receiving channel, and a mounting surface. The mounting surface is positioned external to the fitment body. The teeth receiving channel traverses into and along the fitment body. The first set of braces traverses along the mounting surface of the first dental fitment. The second set of braces traverses along the mounting surface of the second dental fitment.

The current application claims a priority to the U.S. Provisional Patent application Ser. No. 62/980,507 filed on Feb. 24, 2020.

### FIELD OF THE INVENTION

The present invention generally relates to orthodontic braces. More specifically, the present invention relates to cosmetic coverage of teeth featuring a retainer and brackets.

### BACKGROUND OF THE INVENTION

An orthodontic device that is comfortable to wear while producing no irritation is in demand. Orthodontic retainers are pieces of custom-made hardware, usually constructed of wires or clear plastic, that hold teeth in position after surgery or that are used for minor tooth movements and the realignment of teeth. Orthodontic hardware that is used for correction of teeth position alters the image or general appearance of the user's teeth, especially when the user is smiling, and thus is often considered unattractive by its users. Most people are concerned about their personal appearance and are willing to take extreme measures to make themselves look more attractive. Accordingly, it would be beneficial if orthodontic retainers were to address users' cosmetic/aesthetic perceptions in addition to addressing the fundamental structural aspects of users' bite or other flaws of the teeth.

To solve this problem, many different brackets have been developed, including clear and tooth-colored plastic brackets that attach to the teeth using adhesives. However, such brackets do not provide sufficient strength for long-term use. Brackets made of other materials, such as porcelain, have been proven to be unaesthetic and bulky, and they lack the strength of metal brackets.

Various types of retainers are available, including Hawley, vacuum-formed (Essix), pressure-formed (Zendura), and bonded (fixed) retainers. Most are associated with problems such as lack of fit, lack of alignment, discomfort, lack of patient motivation, and breakage.

Vacuum-formed retainers can be more comfortable than traditional retainers, because they require no metal or wires, which can irritate gums and teeth. However, vacuum-formed retainers can be weak, being made of plastic that wears out and distorts when the user grinds his or her teeth. Accordingly, there is a need to develop a device that eliminates or alleviates these problems.

The present invention is intended to address problems associated with and/or otherwise improve on conventional devices through an innovative orthodontic device that is designed to provide a cosmetic effect to the teeth while incorporating other problem-solving features.

### SUMMARY OF THE INVENTION

The present invention is a cosmetic dental insert that combines vacuum-formed retainers with orthodontic braces. The cosmetic dental insert comprises a first dental fitment, a second dental fitment, a first set of braces, and a second set of braces. The first dental fitment and the second dental fitment each comprises a fitment body, a teeth receiving channel, and a mounting surface. The mounting surface is positioned external to the fitment body. The teeth receiving channel traverses into and along the fitment body. The first set of braces traverses along the mounting surface of the first dental fitment. The second set of braces traverses along the mounting surface of the second dental fitment.

### BRIEF DESCRIPTION OF THE DRAWINGS

FIG. 1 is a diagram view of the present invention being worn on a wearer.

FIG. 2 is a diagram view of the present invention.

FIG. 3 is a diagram view of the present invention, in accordance to another embodiment.

### DETAIL DESCRIPTIONS OF THE INVENTION

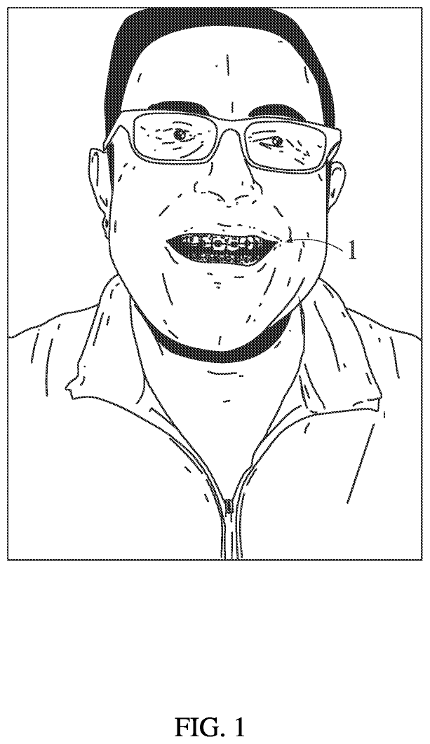

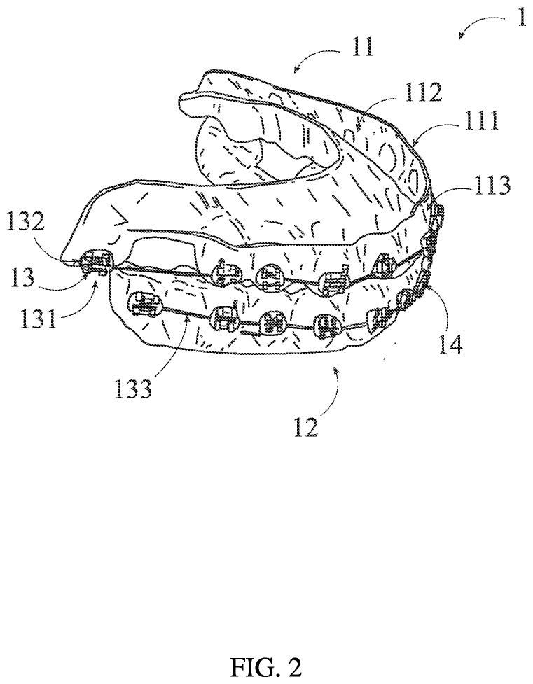

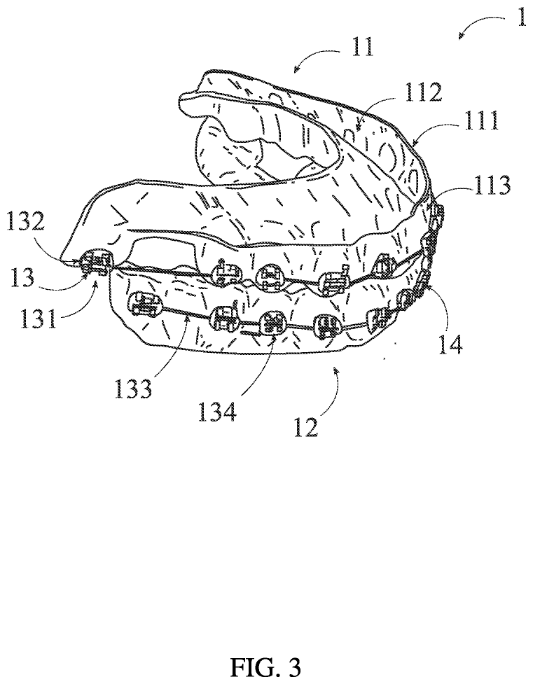

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole. The present invention is a cosmetic dental insert 1 that combines vacuum-formed retainers with orthodontic braces to produce a cosmetically appealing appearance, as shown in FIGS. 1-3. The cosmetic dental insert 1 comprises a first dental fitment 11, a second dental fitment 12, a first set of braces 13, and a second set of braces 14, as shown in FIGS. 2-3. The first dental fitment 11 and the second dental fitment 12 each comprises a fitment body 111, a teeth receiving channel 112, and a mounting surface 113, as shown in FIGS. 2-3. The mounting surface 113 is positioned external to the fitment body 111. The teeth receiving channel 112 traverses into and along the fitment body 111. The first set of braces 13 traverses along the mounting surface 113 of the first dental fitment 11. The second set of braces 14 traverses along the mounting surface 113 of the second dental fitment 12. In the preferred embodiment of the present invention, the cosmetic dental insert 1 may take the form of a customized piece that accommodates the wearer's dental profile. In another embodiment, the cosmetic dental insert 1 may take the form of a one size fit all fitted piece. In the preferred embodiment of the present invention, the first dental fitment 11 and the second dental fitment 12 may take the form of vacuum formed retainers. In another embodiment, the first dental fitment 11 and the second dental fitment 12 may take the form of vacuum formed cosmetic retainer inserts that conforms to the wearer's teeth. In the preferred embodiment of the present invention, the first dental fitment 11 and the second dental fitment 12 is made out of any suitable material, such as, but not limited to dental safe polycarbonate, nylon, thermoset plastics, or any other suitable material. In the preferred embodiment of the present invention, the first set of braces 13 and the second set of braces 14 may take the form of cosmetic, non-functional orthodontic braces that complements the cosmetic dental insert 1 ornamental design. In the preferred embodiment of the present invention, the first set of braces 13 and the second set of braces 14 is made out of any suitable material, such as, but not limited to dental safe alloys, polymers, or any other suitable material. In the preferred embodiment of the present invention, the first dental fitment 11 may accommodate the upper teeth of the wearer, where the second dental fitment 12 may accommodate the lower teeth of the wearer. The wearer may wear the first dental fitment 11, the second dental fitment 12, or a combination of the two such that the wearer's teeth appear to have orthodontic braces. In the preferred embodiment of the present invention, the first dental fitment 11 and the second dental fitment 12 each are translucent. In the preferred embodiment of the present invention, the teeth receiving channel 112 serves as the teeth receiving side of the first dental fitment 11 and the second dental fitment 12. In the preferred embodiment of the present invention, the mounting surface 113 serves as the surface to mount the first set of braces 13 and the second set of braces 14 to the first dental fitment 11 and the second dental fitment 12, respectively.

In the preferred embodiment of the present invention, the first set of braces 13 and the second set of braces 14 each comprises a plurality of brackets 131, a plurality of bands 132, and a wire 133. The plurality of brackets is distributed along the first dental fitment 11 and the second dental fitment 12. The wire 133 traverses through the plurality of brackets. The wire 133 is connected adjacent to the plurality brackets through the plurality of bands 132. In the preferred embodiment of the present invention, the plurality of brackets may resemble the cosmetic design of orthodontic dental brace brackets embedded along the first set of braces 13 and the second set of braces 14. In the preferred embodiment of the present invention, the plurality of bands 132 may resemble the cosmetic design of orthodontic dental brace bands connected along the plurality of brackets. In the preferred embodiment of the present invention, the wire 133 may resemble the cosmetic design of orthodontic dental brace wires 133 traversing through the plurality of brackets. In the preferred embodiment of the present invention, the first set of braces 13 and the second set of braces 14 each are the same in color. In another embodiment of the present invention, the first set of braces 13 and the second set of braces 14 each are different in color. In the preferred embodiment of the present invention, each of the plurality of bands 132 are the same color. In another embodiment of the present invention, each of the plurality of bands 132 are different in color.

In another of the present invention, the first set of braces 13 and the second set of braces 14 each further comprises a pattern of colored bands 134, as shown in FIG. 3. The pattern of colored bands 134 is distributed about the first set of braces 13 and the second set of braces 14. In the preferred embodiment of the present invention, the pattern of colored bands 134 may take the form of an alternating-colored pattern of bands along the first set of braces 13 and second set of braces 14. In various embodiments, the pattern of colored bands 134 may take the form of various colored patterns that complements the design of the cosmetic dental insert 1.

Although the invention has been explained in relation to its preferred embodiment, it is to be understood that many other possible modifications and variations can be made without departing from the spirit and scope of the invention as hereinafter claimed.

What is claimed is:

1. A cosmetic dental insert comprising:
a first dental fitment;
a second dental fitment;
a first set of braces;
a second set of braces;
the first dental fitment and the second dental fitment each comprising a fitment body, a teeth receiving channel, and a mounting surface;
the mounting surface being positioned external to the fitment body;
the teeth receiving channel traversing into and along the fitment body;
the first set of braces traversing along the mounting surface of the first dental fitment; and
the second set of braces traversing along the mounting surface of the second dental fitment.

2. The cosmetic dental insert, as claimed in claim 1, comprising:
the first set of braces and the second set of braces each comprising a plurality of brackets, a plurality of bands, and a wire;
the plurality of brackets being distributed along the first dental fitment and the second dental fitment;
the wire traversing through the plurality of brackets; and
the wire being connected adjacent to the plurality brackets through the plurality of bands.

3. The cosmetic dental insert, as claimed in claim 1, comprising:
the first set of braces and the second set of braces each comprising a pattern of colored bands; and
the pattern of colored bands being distributed about the first set of braces and the second set of braces.

4. The cosmetic dental insert, as claimed in claim 1, wherein the first set of braces and the second set of braces are each the same in color.

5. The cosmetic dental insert, as claimed in claim 1, wherein the first set of braces and the second set of braces are each different in color.

6. The cosmetic dental insert, as claimed in claim 1, wherein each of the plurality of bands is the same color.

7. The cosmetic dental insert, as claimed in claim 1, wherein each of the plurality of bands is different in color.

8. The cosmetic dental insert, as claimed in claim 1, wherein the first dental fitment and the second dental fitment are each translucent.
